(19) United States
(12) Patent Application Publication
(10) Pub. No.: US 2012/0223578 A1
(43) Pub. Date: Sep. 6, 2012

(54) METHOD AND DEVICE FOR SUPPLYING POWER

(75) Inventor: Sven Bartelt-Muszynski, Schwedt (DE)

(73) Assignee: SBU PHOTOVOLTAIK GMBH, Schwedt (DE)

(21) Appl. No.: 13/241,659

(22) Filed: Sep. 23, 2011

(30) Foreign Application Priority Data
Mar. 4, 2011 (DE) 10 2011 013 609.6
Mar. 4, 2011 (DE) 20 2011 003 799.1

(51) Int. Cl. H02J 4/00

(52) U.S. Cl. 307/24

(57) ABSTRACT

The control of users and generators of electrical energy behind the legal interface with the energy provider. In particular, the invention relates to the generation of renewable electrical energy, such as wind energy, solar energy, energy from biogas plants, geothermal energy etc., and to the electricity thus generated. The proposed technical energy management avoids feeding energy into the central grid without precluding the use of energy from the central power grid if necessary.

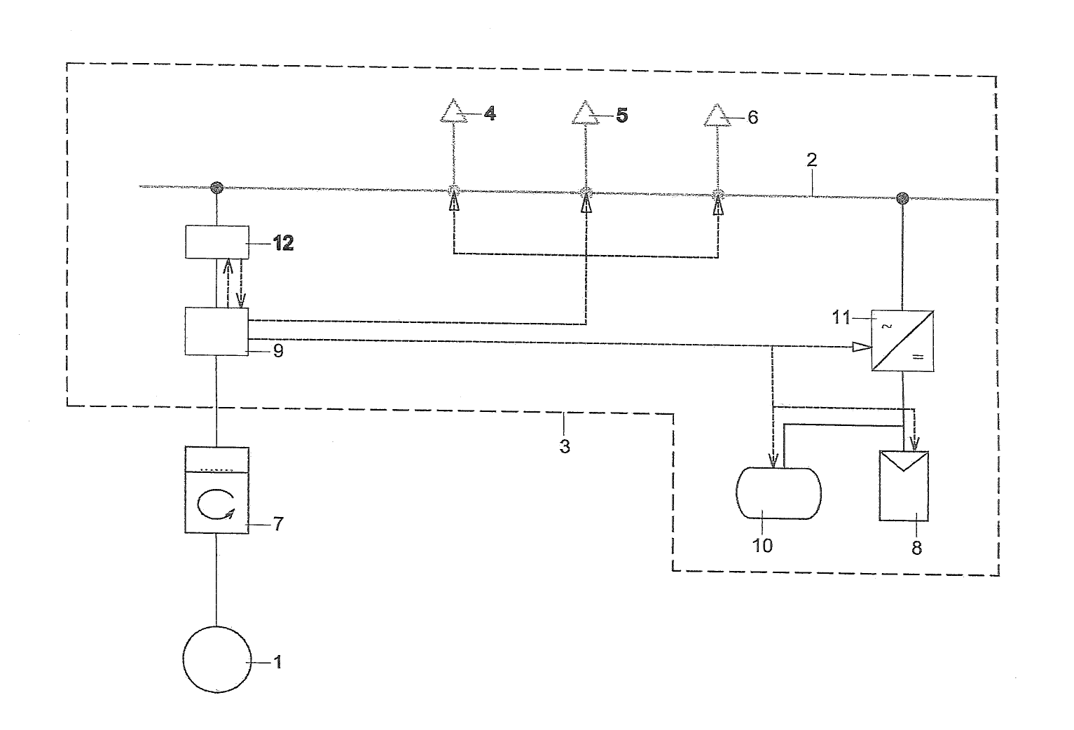

### BACKGROUND OF THE INVENTION

1. Field of the Invention

The invention relates to the control of users and generators of electrical energy behind the legal interface with the energy provider. In particular, the invention relates to the generation of renewable electrical energy, such as wind energy, solar energy, energy from biogas plants, geothermal energy etc., and to the electricity thus generated, which is usually fed in a grid-connected way into the central energy grid of an energy provider because there is no guarantee that this electrical energy will be used directly by the internal loads at all times.

2. Description of the Related Art

In Germany and most other countries, grid-connected photovoltaic systems have so far not been competitive. The generation of solar power therefore has been and still is supported through Renewable Energy Laws.

Based on these laws, operators of photovoltaic systems are reimbursed for feeding their generated power into central energy grids, the feed-in tariffs being higher than the electricity prices traded at the electricity exchanges. The power generation costs are passed on to all consumers.

As new solar power installations are rapidly being set up, the costs for the consumer would rise to levels that are no longer acceptable. For this reason, the solar power feed-in tariffs were lowered by 30% in 2010 for the first time and are to be further lowered in each of the coming years. From the point of view of the energy grid operators, solar power will become competitive when the energy grid operator can buy solar power at the electricity exchange for a better price than he would pay for traditional power from sources like gas, oil or coal or for power from nuclear power plants.

In light of this development and also the expenses related to the grid connection, like costs of grid-connecting devices, electricity billing, etc., as well as the amortization of the costs for solar power installations, small producers of solar electricity, whose generating capacity is generally barely sufficient to cover their own needs, have to ask themselves whether feeding into the grid still makes sense. The same applies to other producers of electricity from other renewable energy sources.

It is therefore the object of the invention to suggest a device and a method that allows operators of power generation installations based on renewable energy to use the energy generated by said power installations without detouring through a central grid.

### BRIEF SUMMARY OF THE INVENTION

In accordance with the invention, for the purpose of supplying power to a consumer who is connected to a central energy supply grid and who has an amount of energy from renewable energy sources at his disposal which can be fed into the central energy supply grid, it is suggested that the power consumption of the active load units of the consumer is metered and the active load units are directly supplied with energy by power generators from renewable energy sources and/or from an energy storage of renewable energy, wherein, depending on the metered power consumption data and by means of a control unit,
a) in case of a metered over-consumption of the active load units compared to an upper threshold value, the missing amount of energy is supplied by switching on additional peripheral power generators and/or from an energy storage and/or from the central energy supply grid and/or the power consumption of the load is reduced, and
b) in case of a metered consumption of the load below a threshold value, the current output of the power generators is reduced and/or the excess amount of energy is fed into a storage and/or the power consumption of the load is increased,
   so that no power from peripheral power generators from renewable energy sources and/or from an energy storage is fed into the central energy supply grid.

The term load as used here denotes a system located behind the meter of the central energy supply grid which consists of power load units, e.g. a single-family house (system) with load units such as a washing machine, TV sets, heating, machines etc.

The consumer is simultaneously operator of the peripheral power generators, that is, energy producer. He can thus be called a prosumer in an internal supply grid.

The amount of energy that can be provided is the amount of energy that the power generators can currently provide. If a storage is available, the amount of energy that can be provided can include the stored energy.

The threshold values are predefined threshold values and/or the threshold values are calculated from the amount of energy that the power generators can currently provide and also the stored amount of energy, if available, or correspond to the amount of energy that can be provided.

The introduction of threshold values gives the system a greater flexibility. In particular, it is possible to switch the load units on or off after a delay, preferably if the metered consumption value permanently falls below or exceeds the relevant threshold value in a given time window.

In the manner described, the supply of power to the various loads is fully ensured without feeding any power that is or can be provided by the power generators into the central energy supply grid.

What seems to be incomprehensible at first glance entails a number of advantages for the operators of power generation installations based on renewable energy.

The operators are thus enabled to use the energy generated by these power installations without detouring through a central energy supply grid.

Small producers of electricity whose generation capacity generally covers their own needs are in this way spared the expenses related to feeding into the grid, as, for example, for grid-connecting devices.

Operators of central energy supply grids are no longer needed as contractual partners, just as financial billing etc. is no longer necessary.

A solar power installation set up in the garden or on the roof of a garage with an output of, say, 2 to 3 kW can cover the needs of a single-family house to a large extent.

Each kilowatt hour generated by the private power installation reduces the electricity bill and helps to amortize the costs of acquisition of a 2 kW photovoltaic system, which are currently in the range of about 2000 to 3000 [symbol] .

The operator of a central energy supply grid has the advantage of less load on his grid.

The supply of power to the load units of the load can be further optimized through advantageous embodiments. In an advantageous embodiment, for example, the measuring device permanently records the power consumption of the load, so that the control unit can compare it to the data about the amount of energy currently provided by the power generator and/or the storage and, consequently, can switch on operational load units, e.g. a pre-programmed washing machine, to make full use of the amount of energy provided.

Similarly, load units can be switched off depending on the consumption of electricity from the central energy supply grid, thus minimizing the consumption of electricity from the central supply grid.

In a further advantageous embodiment there is a safety circuit which, in case of a loss of measurement results at the measuring device, switches off the load units and takes the power generators and, if available, the energy storages off the internal grid.

In a device for supplying power to loads having an internal supply grid, said internal supply grid being connected via a meter with a central energy supply grid and coupled with power generators from renewable energy sources via an inverter device, a control unit is arranged behind the meter for the amount of energy that can be withdrawn from the central energy supply grid, said control unit being connected with the load units via a measuring device and also being connected with at least one power generator from renewable energy sources and/or an energy storage arranged behind the power generator in such a way that the control unit allows adjustment of the supply of power to the load units through the power generator and/or the energy storage such that no power supplied by power generators from renewable energy sources and/or by an energy storage is fed into the central energy supply grid.

Preferably, depending on the power consumption data metered by the measuring device and by means of the control unit,
a) in case of a metered over-consumption of the active load units compared to an upper threshold value, the missing amount of energy is supplied by switching on additional peripheral power generators and/or from an energy storage and/or from the central energy supply grid and/or the power consumption of the load is reduced, and
b) in case of a metered consumption of the load below a threshold value, the current collection from the power generators is reduced and/or the excess amount of energy is fed into a storage and/or the power consumption of the load is increased.

In an advantageous embodiment, the control unit has a delay circuit, so that the load units can be switched on or off after a delay, preferably if the metered consumption value permanently falls below or exceeds the relevant threshold value in a given time window.

### BRIEF DESCRIPTION OF THE DRAWING

The basic design of the power supply is depicted in the drawing.

### DETAILED DESCRIPTION OF THE INVENTION

The device for supplying power to loads 3 has an internal supply grid 2, said internal supply grid 2 being connected via a meter 7 with a central energy supply grid 1 and coupled with power generators 8 from renewable energy sources via an inverter device 11.

A control unit 9 is arranged behind the meter 7 for the amount of energy that can be withdrawn from the central energy supply grid 1, said control unit 9 being connected with the load units 4, 5, 6 via a measuring device 12 and also being connected with at least one power generator 8 from renewable energy sources and/or an energy storage 10 arranged behind the power generator 8. The control unit 9 allows adjustment of the supply of power to the active load units 4, 5 through the power generator 8 and/or the energy storage 10, while the measuring device 12 permanently records the power consumption of the load 3.

In one embodiment, the adjustment of the supply takes place in the following way:

The power requirements of the active load units 4, 5 are metered and the active load units 4, 5 are directly supplied with energy by power generators 8 from renewable energy sources and/or from the energy storage 10.

If the measuring device 12 and thus the control unit 9 detect an over-consumption of the active load units 4, 5 compared to the amount of energy that the power generator 8 and the energy storage 10 can provide, the missing amount of energy is supplied by switching on additional peripheral power generators, if available, and/or from the central energy supply grid 1. Of course it is also possible to switch off load units 5, 6 to reduce the consumption of electricity from the central energy supply grid 1.

If it is detected that the active load units 4, 5 consume less than the amount of energy provided by the power generators 8, then the current collection from the power generators 8 is reduced and/or the excess amount of energy is fed into the energy storage 10 and/or the power consumption of the load 3 is increased by switching on the operational load unit 6.

For optimized operation of the system it is suggested to predefine or calculate threshold values, that is, one threshold value for the minimum consumption and one allowed threshold value for the maximum consumption.

If the consumption falls below the threshold value for the minimum consumption, then, as a first step, load units 4, 5, 6 are successively switched on, and, afterwards, the power generator 8 is throttled or switched off. If the total consumption exceeds the upper threshold value, additional power generators 8 are switched on as a first step, and load units 4, 5, 6 are switched off afterwards, until consumption falls below the threshold value.

If there are no more load units 4, 5, 6 that can be switched off, it becomes necessary to resort to the central energy supply grid 1.

For this reason it is advantageous to adapt the power generation capacity of the power generators 8 to the anticipated requirements of the connected load units 4, 5, 6 of the load 3, and preferably to design that capacity to be slightly higher than the requirements.

Furthermore, the measuring device 12 and/or the control unit 9 should have a safety circuit which, in case of a loss of measurement results at the measuring device 12, effects that the load units 4, 5, 6 are switched off and the power generators 8 and, if available, the energy storages 10 are taken off the internal grid 2.

As an alternative to switching load units 4, 5, 6 on or off using the control unit 9, it is also possible to operate the load units 4, 5, 6 such that they can be switched on or off dependent on time.

### REFERENCE SYMBOL LIST

1 central energy supply grid
2 internal supply grid
3 load
4 load unit
5 load unit
6 load unit
7 meter
8 power generator from renewable energy sources
9 control unit
10 energy storage
11 inverter device
12 measuring device(s)

1. A method for supplying power to a load (3), said load being connected to a central energy supply grid (1) and having an amount of energy from renewable energy sources at its disposal which can be fed into the central energy supply grid (1), wherein the power consumption of active load units (4, 5) of the load (3) is metered and the active load units (4, 5) are directly supplied with energy by power generators (8) from renewable energy sources and/or from an energy storage (10) of renewable energy, wherein, depending on the metered power consumption data and by means of a control unit (9),
a) in case of a metered over-consumption of the active load units (4, 5, 6) compared to an upper threshold value, the missing amount of energy is supplied by switching on additional peripheral power generators (8) and/or from an energy storage (10) and/or from the central energy supply grid (1) and/or the power consumption of the load (3) is reduced, and
b) in case of a metered power consumption of the load (3) below a threshold value, the current collection from the power generators (8) is reduced and/or the excess amount of energy is fed into a storage (10) and/or the power consumption of the load (3) is increased,
so that no power from peripheral power generators (8) from renewable energy sources and/or from an energy storage (10) is fed into the central energy supply grid (1).

2. The method of claim 1, wherein the threshold values are predefined threshold values or are calculated from or correspond to the amount of energy that the power generators (8) can currently provide and also the stored amount of energy, if available.

3. The method of claim 1, wherein the measuring device (12) records the power consumption of the load (3) permanently.

4. The method of claim 1, wherein the power consumption is increased by switching on operational load units (4, 5, 6) of the load (3).

5. The method of claim 1, wherein the power consumption is reduced by switching off load units (4, 5, 6) of the load (3).

6. The method of claim 1, wherein the load units (4, 5, 6) are switched on or off after a delay, preferably if the metered consumption value permanently falls below or exceeds the relevant threshold value in a given time window.

7. The method of claim 1, wherein in case of a loss of measurement results at the measuring device (12), the load units (4, 5, 6) are switched off and the power generators (8) and, if available, the energy storages (10) are taken off the internal grid (2).

8. The method of claim 1, wherein during project planning the power generation capacity of the power generators (8) is adapted to the anticipated requirements of the connected load units (4, 5, 6).

9. A device for supplying power to loads (3) having an internal supply grid (2), said internal supply grid being connected via a meter (7) with a central energy supply grid (1) and coupled with power generators (8) from renewable energy sources via an inverter device (11), wherein a control unit (9) is arranged behind the meter (7) for the amount of energy that can be withdrawn from the central energy supply grid (1), said control unit being connected with the load units (4, 5, 6) via a measuring device (12) and also being connected with at least one power generator (8) from renewable energy sources and/or an energy storage (10) arranged behind the power generator (8) in such a way that the control unit (9) allows adjustment of the supply of power to the load units (4, 5, 6) through the power generator (8) and/or the energy storage (10) such that no power supplied by power generators (8) from renewable energy sources and/or by an energy storage (10) is fed into the central energy supply grid (1).

10. The device of claim 9, wherein the control unit (9) has information available about the amount of energy currently provided by the power generators (8) and/or the energy storage (10).

11. The device of claim 9, wherein the control unit (9) is coupled with the load units (4, 5, 6) in such a way that they can be switched on or off or their power consumption can be reduced via signals sent by the control unit (9).

12. The device of claim 9, wherein the control unit (9) has a delay circuit, so that the load units (4, 5, 6) are switched on or off after a delay.

13. The device of claim 9, wherein the measuring device (12) and/or the control unit (9) have a safety circuit which, in case of a loss of measurement results at the measuring device (12), effects that the load units (4, 5, 6) are switched off and the power generators (8) and, if available, the energy storages (10) are taken off the internal grid (2).

14. The device of claim 9, wherein the load units (4, 5, 6) can be operated such that they can be switched on or off dependent on time.

15. The method of claim 1, wherein during project planning the power generation capacity of the power generators (8) is designed to be slightly higher than the anticipated requirements of the connected load units (4, 5, 6).

16. The device of claim 9, wherein the control unit (9) has a delay circuit, so that the load units (4, 5, 6) are switched on or off after a delay if the metered consumption value permanently falls below or exceeds the relevant threshold value in a given time window.
